(19) United States
(12) Patent Application Publication
(10) Pub. No.: US 2002/0165934 A1
(43) Pub. Date: Nov. 7, 2002

(54) Displaying a subset of network nodes based on discovered attributes

(76) Inventors: Jeffrey Richard Conrad, Fort Collins, CO (US); Debra Carol Bomgardner, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/847,382

(22) Filed: May 3, 2001

(51) Int. Cl. G06F 15/16

(52) U.S. Cl. 709/217; 709/223; 345/734

(57) ABSTRACT

A network management tool operable to display a visual representation (e.g., a network topology) of network devices monitored by the network management tool is disclosed. Network management software (NMS) is executed on a network management node for monitoring one or more networks. The NMS includes a display module and a filter module. The filter module allows a user, such as a network administrator, to select a plurality of filters that limit the information provided in the visual representation. The network administrator may select filters associated with particular types of nodes and/or status levels of the selected nodes. Information associated with the selected filters may be retrieved from a database containing information about the nodes in the monitored networks. The display module creates the visual representation using the retrieved information. The visual representation is divided into segments, and the visual representation may be displayed on a single display page.

### TECHNICAL FIELD OF THE INVENTION

The invention relates to computer network management. More particularly, the present invention relates to a network management tool including a display feature for displaying network nodes having selected attributes.

### BACKGROUND OF THE INVENTION

Network communications have become a fundamental part of today's computing. It is not uncommon to find two or more computer systems working together to resolve issues, such as simulations, modeling, forecasting, and the like. These efforts have been so successful, users have been inclined to design and implement larger and more powerful networks.

As networks grow larger, increasingly complex, and interface with a variety of diverse networks, it is the task of a network manager (or administrator/user) to keep track of the devices on the networks, to monitor performances and load, to diagnose, and to correct problems with the network.

To assist a network manager, network management software (NMS) may be used in the management of a network. A conventional NMS may be typically executed on a management device or management node of the network. From the management node or device, the conventional NMS may be configured to determine a network topology, detect malfunctioning remote network devices or communication links, monitor network traffic, and the like.

As part of the monitoring duties, the network manager may configure the NMS to occasionally query or poll remote network devices for information. The information may include status data, port information, address, etc. The information required may be crucial for the network manager to assess the overall status of the network.

FIG. 6 illustrates a block diagram of a conventional management node or device 600 implementing a conventional data collection from a remote node. In particular, the management node 600 includes a NMS 610 and a network interface 620. The NMS 610 may be configured to provide the functionality for a user, (e.g., a network manager), to manage a network 615 through the network interface 620.

As part of the NMS 610, the NMS 610 may include a data collector module 630 configured to perform data collection events, such as retrieving user-specified information from nodes (not shown) in the network 615 at scheduled times. The retrieved information may be stored, for example, in an associated output file in the management node 600. The associated output file may be analyzed by additional network modules of the NMS 610 to assist in the assessment of the status and maintenance of the network 615.

The NMS 610 may include a discovery module 635 connected to the data collector module 630. The discovery module 635 may perform conventional functions for discovering nodes in the network 615 and interconnections of the network 615. For example, the discovery module 635 may monitor the network topology of the network 615. To discover network topology changes on the network, the data collector module 630 generates events, or traps (Simple Network Management Protocol (SNMP) vernacular), which may include an object identifier and object change information for receiving information from the nodes in the network 615. The discovery module 635 may populate a topology data base (not shown) with the information regarding the changed topology.

A display module 612, which allows a network manager to view the nodes and network infrastructure of one or more networks monitored by the NMS 610 on a display 615 may generate a topology based on the changed topology information. For example, the display module 612 transmits a submap including the changed topology to the display 615. The submap may include nodes in the network 615 and may display other information, such as node status and the like, related to the information gathered by the data collector 630. The display module 612 may typically display multiple submaps for each network or for a portion of each network monitored by the NMS 610.

The network administrator may view the submaps to identify network problems. However, the network administrator may need to view multiple submaps to identify each node having problems. Additionally, the submaps may include network infrastructure (e.g., personal computers, unused network equipment, unmanaged devices or other network devices, such as routers, bridges, switches, modems, and the like), which may unnecessarily clutter the view provided in the submap and reduce the amount of necessary data (e.g., problematic nodes) that can be displayed in a single view. Accordingly, the network manager may waste valuable time browsing through multiple submaps and determining the connectivity between nodes in different submaps, when identifying problematic nodes. Thus, the period of time to resolve network problems may be significant.

### SUMMARY OF THE INVENTION

An aspect of the present invention is to provide a network management tool. In one respect, the present invention includes a method of providing information related to one or more networks. The method comprises the steps of receiving filter information including to at least one selected filter; retrieving network device information based on the filter information; and creating a visual representation of the network device information. The visual representation may include one or more network segments, and the network device information may be related to one or more network devices in each of the networks. The step of retrieving information may further comprise retrieving network segment information for each of the network devices, and the network segment information is associated with the network segments in the visual representation.

The visual representation may be divided into a plurality of segments and displayed on a single display page. Also, the visual representation may include indicia indicating the division between each of the plurality of segments. The visual representation illustrates the connectivity of the network devices.

The step of receiving filter information may further comprise a step of receiving the filter information, whereby the filter information includes at least one node type. The filter information may further include at least one node attribute. The node attribute may include node status, and the filter information may further include at least one status level.

The method of the present invention include steps that may be performed by computer-executable instructions embedded on a computer-readable medium.

In another respect, the present invention includes a network management node connected to one or more networks. The network management node includes a plurality of modules stored on a computer readable medium and a database storing information related to a plurality of network devices in the one or more networks. The plurality of modules are operable to receive filter information including to at least one selected filter; retrieve network device information based on the filter information retrieved from the database; and create a visual representation of the network device information. The visual representation may include one or more network segments.

The network management node may also include a display operable to display the visual representation on a single display page, and a network interface operable to transmit the visual representation over the Internet.

In comparison to known prior art, certain embodiments of the invention are capable of achieving certain advantages, including some or all of the following: (1) providing a visual representation of monitored networks on a single display page; (2) illustrating connectivity between network devices in monitored networks in a single visual representation; and (3) improved filtering to limit the amount of information displayed in the visual representation. Those skilled in the art will appreciate these and other advantages and benefits of various embodiments of the invention upon reading the following detailed description of a preferred embodiment with reference to the below-listed drawings.

### BRIEF DESCRIPTION OF THE DRAWINGS

The present invention is illustrated by way of example and not limitation in the accompanying figures in which like numeral references refer to like elements, and wherein:

FIG. 1 illustrates a block diagram of an exemplary system including an exemplary management node employing the principles of the present invention;

FIG. 2 illustrates a block diagram of the management node shown in FIG. 1 according to an embodiment of the present invention;

FIG. 3 illustrates an exemplary filter selection display;

FIG. 4 illustrates an exemplary node view;

FIG. 5 illustrates an exemplary method for providing a node view; and

FIG. 6 illustrates a conventional system including a network management node.

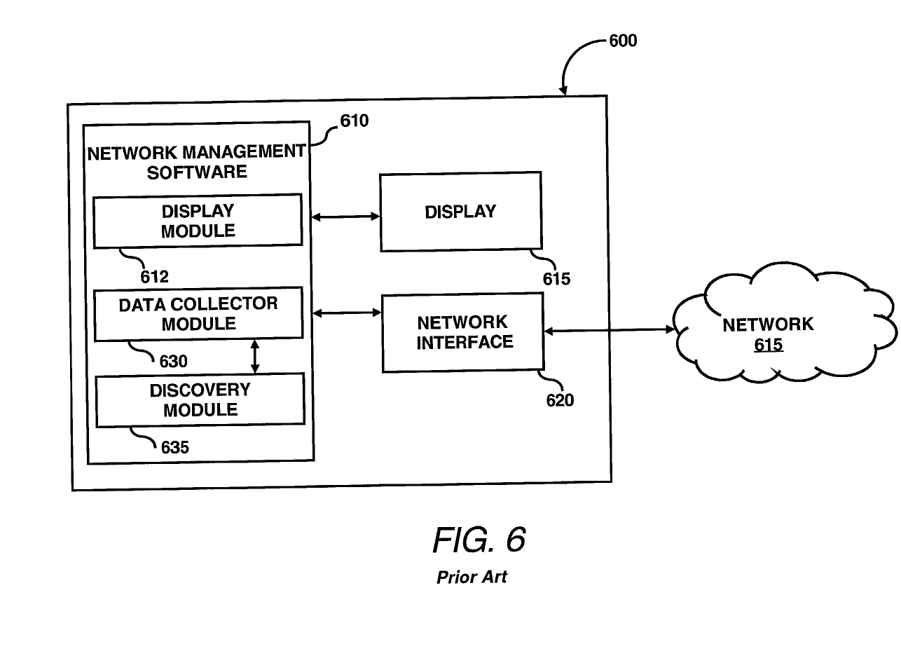

### DETAILED DESCRIPTION OF THE INVENTION

In the following detailed description, numerous specific details are set forth in order to provide a thorough understanding of the present invention. However, it will be apparent to one of ordinary skill in the art that these specific details need not be used to practice the present invention. In other instances, well known structures, interfaces, and processes have not been shown in detail in order not to unnecessarily obscure the present invention.

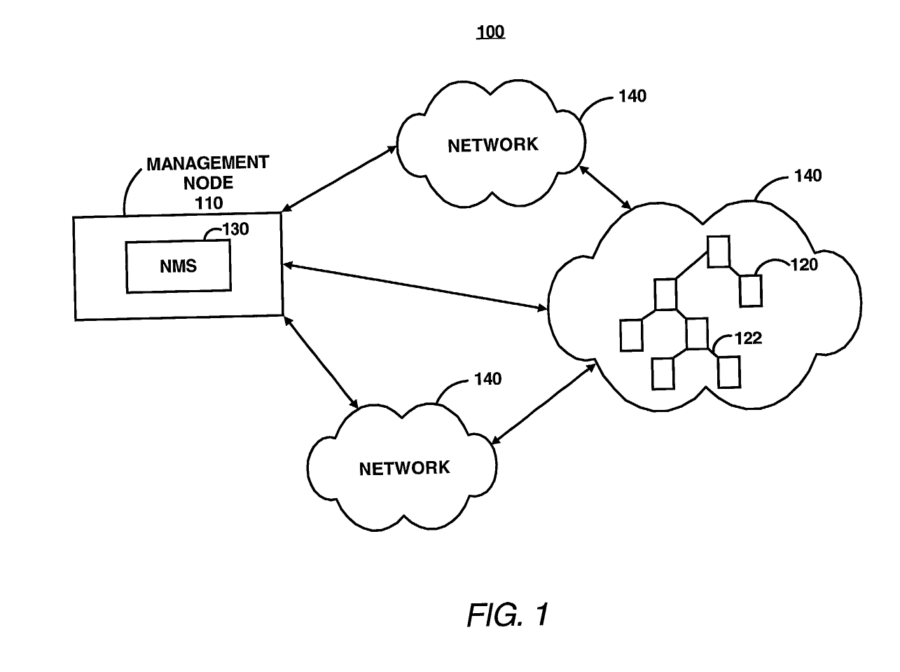

FIG. 1 illustrates a block diagram of a system 100 where an exemplary embodiment of the present invention may be practiced. The system 100 includes a management node 110 interfaced with one or more networks 140. The networks 140 may be connected to each other or only connected to the management node 110. Each network 140 may includes multiple nodes 120 and communication paths 122 (e.g., a network backbone and the like) connecting the nodes 120. The management node 110 may be connected to each node 120 for managing each network 140. For example, the NMS 130 executing on management node 110 may provide the capability of monitoring, troubleshooting, and/or diagnosing of the network nodes 120. The management node 110 may retrieve information from the nodes 120 for purposes of monitoring the networks 140. This may include conventional techniques, such as polling or transmitting data from the nodes 120 at scheduled times.

The management node 110 may be implemented with a server, a workstation, a personal computer and the like. The network nodes 120 may include a variety of electronic devices, such as a router, a hub, a bridge, a printer, a scanner, a server, a workstation, a personal computer, and the like. Also, the nodes may include clients and network infrastructure. The computer networks 140 may be implemented using network protocols such as Ethernet, token ring, X.25, SNMP, etc. Also, the management node 110 may include a network interface that allows a user, such as a network administrator, to manage the networks 140 over the Internet. When using the network interface, the network management node 110, for example, may provide node views and filter selection screens, described below, over the Internet.

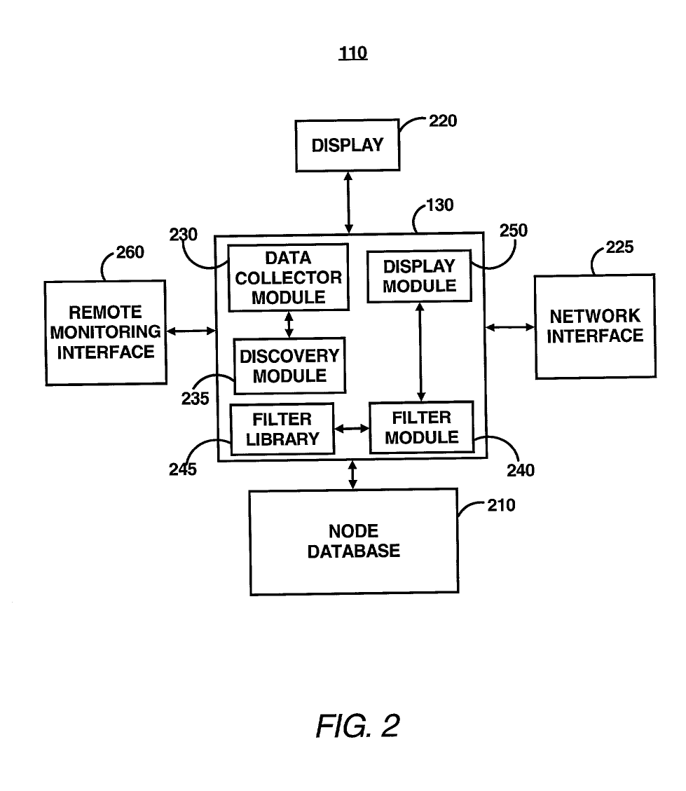

FIG. 2 illustrates a more detailed block diagram of the management node 110 utilizing an exemplary embodiment of the present invention. In particular, the management node 110 includes at least the NMS 130, a node database 210, a network interface 225 connected to each monitored network 140, a display 220 and a remote monitoring interface 260.

The NMS 130 may include multiple modules for performing network management functions, and the modules may be stored on a computer readable medium, as is known to one of ordinary skill in the art. Some of the modules may include a data collector module 230, a discovery module 235, a filter module 240 and a display module 250. The data collector module 230 is configured to perform data collection events, such as retrieving user-specified information from the network nodes 120 in the network 140 through the network interface 225. The retrieved information is stored in the node database 210.

The discovery module 235 may set attributes for network nodes 120 based on data received by the data collector module 230. For example, the data collector module 230 may request information from a network node 120 regarding a management information base (MIB) variable (e.g., RMON MIB, Frame Relay MIB, and the like). Based on information received from the network node 120, the discovery module 235 will set an attribute for the network node 120. For example, if an RMON MIB and/or a Frame Relay MIB is received by the data collector module 230, then the discovery module may set an isRMON and/or isFrame Relay attribute for the network node 120. The attributes may be stored in the node database 210.

The filter module 240 retrieves information from the node database 210 for particular nodes 120 based on filters selected, for example, by the network administrator. The filters may be stored in a filter library 245. The filters stored in the filter library may include attributes received from the network devices 120 and set by the discovery module 235. These attributes may be determined by the MIB for the particular network device. Also, the filters may include attributes that are manually entered (e.g., by a network administrator). The filter module 240 may provide a filter language allowing Boolean queries including the filters for retrieving information for particular nodes 120.

The display module 250 creates a node view, which may include a topology of the nodes that meet the selected filter criteria. The node view may include a single map or view showing the connectivity of the nodes and attributes related to the displayed nodes. The attributes may include status, transactional data, port data, address data, etc. The attributes may be retrieved from the node database 210. The node view is output to the display 220, such that the network administrator may view the node view. The node view allows the network administrator to view all the nodes that meet the selected filter criteria in a single view. Therefore, the need to browse through multiple submaps to identify particular nodes is eliminated.

The network management node 110 may also include a remote monitoring interface 260 that allows information provided by the display module 250 to be accessed remotely, such as over the Internet. For example, node views can be displayed over Internet and filters may be selected over the Internet through the remote monitoring interface 260. The remote monitoring interface 260 may include a network interface and other devices and software known in the art for providing remote connectivity via the Internet.

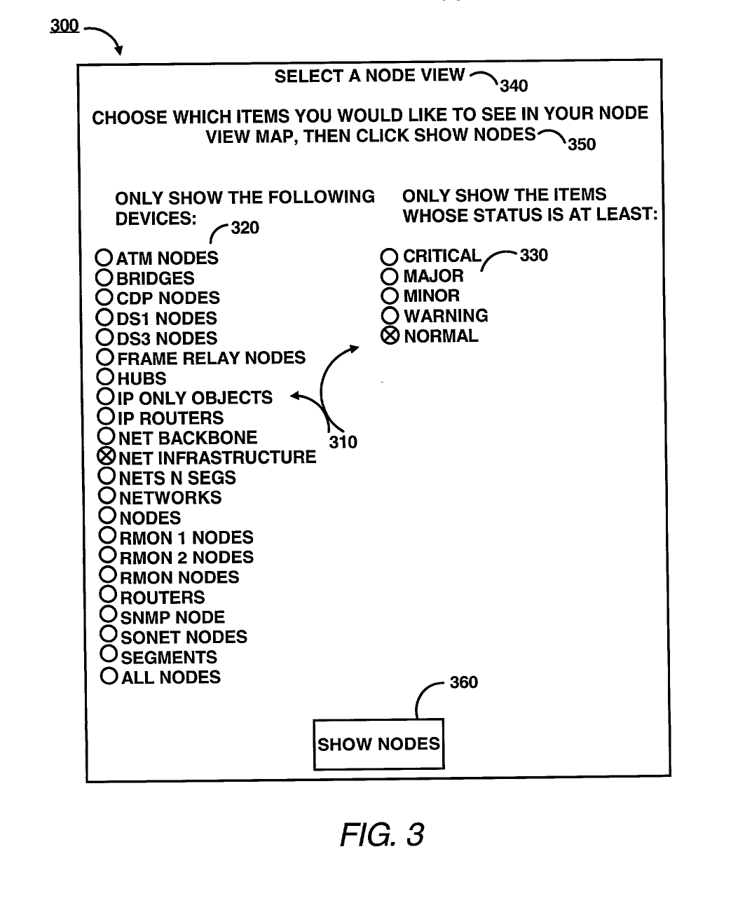

In addition to displaying node views, the display module 250 may display a plurality of filters stored in the filter library 245. FIG. 3 illustrates an exemplary filter selection display 300 for displaying filters 310 that may be selected. The display 300 may include a header 340 and instructions 350 for selecting the displayed filters 310. The filters 310 may include a particular node type, such as the node types 320. Also, the filters 310 may include one or more attributes for each selected node type. The display 300 includes a status attribute 330. The status attribute 330 includes a plurality of status levels (e.g., critical, major, minor, warning and normal). One of the status levels may be selected in addition to one or more of the node types 320. When one or more filters 310 are selected (e.g., one or more node types 320 and a status level of the status attribute 330 are selected and a show nodes button 360 is selected), the display module 250 creates a node view including the nodes that meet the selected filter criteria. The node view is then displayed on the display 220.

The status level of the nodes and other attributes of the nodes 120 may be stored in the node database 210. The status level may be determined by a baselining technique, described in co-pending U.S. Pat Application No. TBD, Attornet Docket No. 10006651-1, herein incorporated by reference, or conventional techniques, such as monitoring Internet Control Message Protocol (ICMP) status messages from the network nodes 120. Although only one attribute 330 is shown in the display 300, other attributes may also be utilized by the display module 250. Also, the list of filter types 320 shown in the display 300 is not exhaustive, and one of ordinary skill in the art will readily recognize that other filters 310 may be utilized by the display module 250 to create and display a node view.

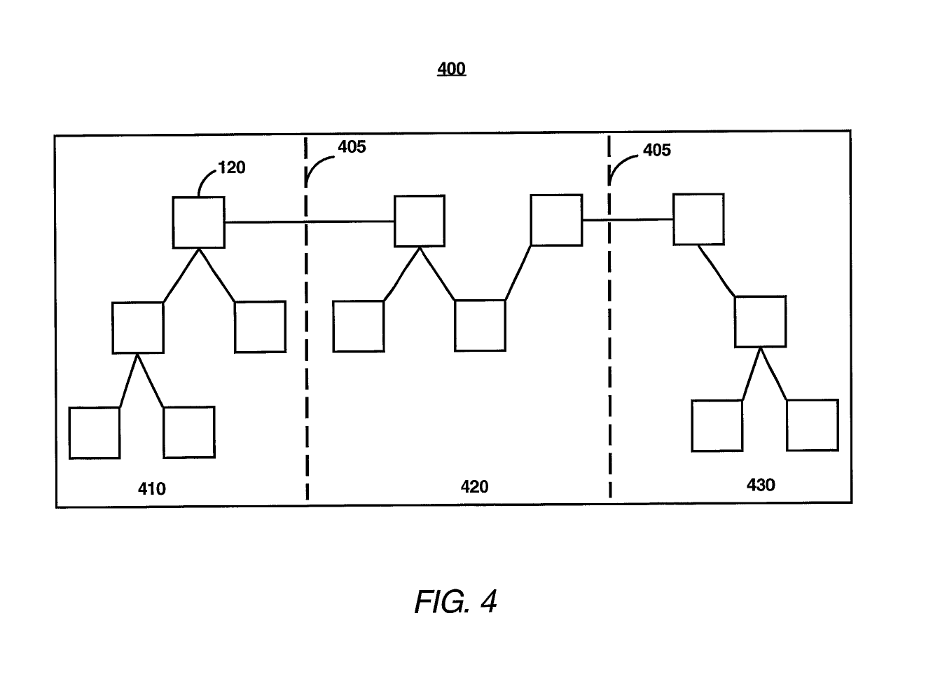

FIG. 4 illustrates an exemplary node view 400 created by the display module 250 based on one or more of the filters 310 that are selected. The node view 400 includes the nodes 120 that meet the selected filter criteria. The connectivity of the nodes are shown based on segments, and the display module 250 may compress the node view using the segments. A segment includes all the nodes physically connected on the same wire. A segment for example, may include portions of a network or a network connected on the same wire. A router, which bridges two networks, couples two segments. Segment information may be stored in the node database 210 with attribute information for each node 120. The display module 250 may retrieve the segment information and the status level from the node database 210 for each node 120 that meets the selected filter criteria. The display module 250 may create the node view 400 based on the retrieved information.

The node view 400 for this example includes three segments 410-430, and each segment 410-430 includes nodes 120 that meet selected filter criteria. The segments 410-430 are separated by dashed lines 405. Therefore, the network administrator may view the node view 400 to quickly ascertain the connectivity of the nodes 120. It will be apparent to one of ordinary skill in the art that indicia, other than a dashed line, may be used to identify different segments. Nodes 120 in the same segment are considered to be connected and are shown as connected in the node view 400.

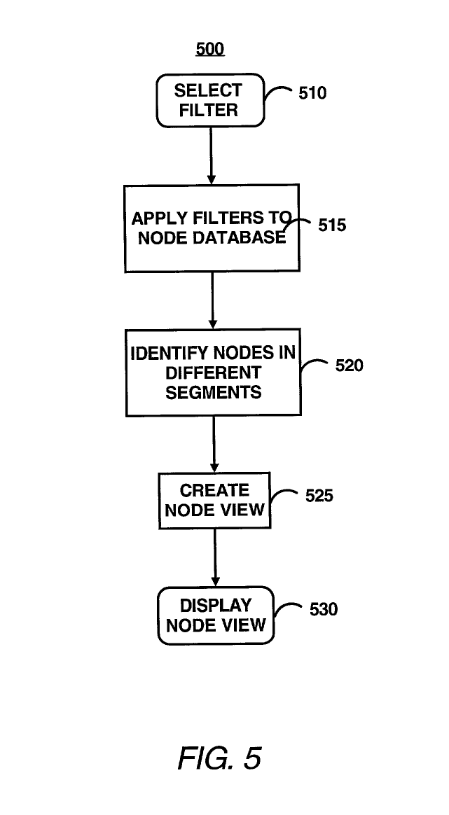

FIG. 5 illustrates an exemplary method for creating a node view. In step 510, a user, such as a network administrator, selects one or filters 310. For example, a network administrator may select Internet Protocol (IP) routers having a “major” status level. In step 515, the selected filters are applied to the node database 210. For example, the display module 250 receives the selected filters from the filter module 240 and retrieves the nodes 120 that meet the criteria of the selected filters. Information for each node 120 that is an EP router having a status level of major or greater (i.e., a status level of major or critical) is retrieved from the node database 210.

In step 520, the display module 250 identifies the segment for each node 120 that meets the selected filter criteria. The segment information may be retrieved from the node database 210 along with other relevant information.

In step 525, the display module 250 creates a node view based on the information retrieved from the node database 210. Then, the node view is displayed on the display 230 or on a remote display over the Internet (step 530). The node view may divided into segments, and the node view may be displayed on a single display page, such that multiple submaps may not be needed to view the connectivity of the nodes.

The method shown in FIGS. 5 and described above can be performed by a computer program. The computer program can exist in a variety of forms both active and inactive. For example, the computer program can exist as software comprised of program instructions or statements in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of executable software program(s) of the computer program on a CD ROM or via Internet download. In a sense, the Internet itself, as an abstract entity, is a computer readable medium. The same is true of computer networks in general.

While this invention has been described in conjunction with the specific embodiments thereof, it is evident that many alternatives, modifications and variations will be apparent to those skilled in the art. There are changes that may be made without departing from the spirit and scope of the invention.

What is claimed is:

1. A method of providing information related to one or more networks, the method comprising steps of:
receiving filter information including at least one selected filter;
retrieving network device information based on said filter information, said network device information being related to one or more network devices in said one or more networks; and
creating a visual representation of said network device information, said visual representation including one or more network segments.

2. The method of claim 1, wherein said step of retrieving information further comprises retrieving network segment information for each of said one or more network devices, said network segment information being associated with said one or more segments in said visual representation.

3. The method of claim 2, wherein said step of creating further comprises a step of creating said visual representation based on said retrieved network segment information.

4. The method of claim 3, wherein said network segment information includes information related to said one or more segments, and said step of creating further comprises creating said visual representation whereby said visual representation is divided into said one or more segments.

5. The method of claim 4, wherein said step of creating further comprises a step of creating said visual representation whereby said visual representation is viewable on a single display page.

6. The method of claim 4, wherein said step of creating further comprises a step of creating said visual representation whereby said visual representation includes an indicia indicating a division between each of said one or more segments.

7. The method of claim 4, wherein said step of creating further comprises a step of creating said visual representation whereby said visual representation illustrates connectivity of said one or more network devices.

8. The method of claim 4, wherein said step of creating further comprises a step of creating said visual representation whereby said visual representation illustrates connectivity of said one or more segments.

9. The method of claim 1, wherein said step of retrieving network device information further comprises a step of retrieving said network device information from a database.

10. The method of claim 1, wherein said step of receiving filter information further comprises a step of receiving said filter information whereby said filter information includes at least one node type.

11. The method of claim 10, wherein said step of receiving filter information further comprises a step of receiving said filter information whereby said filter information includes at least one node attribute.

12. The method of claim 11, wherein said at least one node attribute includes node status, and said step of receiving filter information further comprises a step of receiving said filter information whereby said filter information includes at least one status level.

13. The method of claim 1, further comprising a step of displaying said visual representation.

14. A network management node connected to one or more networks, said network management node comprising:
a plurality of modules stored on a computer readable medium; and
a database storing information related to a plurality of network devices in said one or more networks, wherein said plurality of modules are operable to receive filter information including at least one selected filter; retrieve network device information based on said filter information from said database; and create a visual representation of said network device information, said visual representation including one or more network segments.

15. The network management node of claim 14, further comprising a display operable to display said visual representation on a single display page.

16. The network management node of claim 14, further comprising a network interface operable to transmit said visual representation over the Internet.

17. A computer readable medium on which is embedded a program, the program performing a method for providing information related to one or more networks, the method comprising steps of:
receiving filter information including at least one selected filter;
retrieving network device information based on said filter information, said network device information being related to one or more network devices in said one or more networks; and
creating a visual representation of said network device information, said visual representation including one or more network segments.

18. The computer readable medium of claim 17, wherein said filter information includes at least one node type.

19. The computer readable medium of claim 18, wherein said filter information includes node status, and at least one status level.

20. The computer readable medium of claim 17, wherein said visual representation includes said one or more segments displayed on a single display page.
